(19) United States
(12) Patent Application Publication
(10) Pub. No.: US 2023/0294641 A1
(43) Pub. Date: Sep. 21, 2023

(54) WIPER AND VEHICLE

(71) Applicant: Valeo Systèmes d'Essuyage, Le Mesnil Saint Denis (FR)

(72) Inventors: Haoyi Hong, Le Mesnil Saint Denis (FR); Denis Grandjean, Le Mesnil Saint Denis (FR); Xu Cheng, Le Mesnil Saint Denis (FR); Jinlong Pu, Le Mesnil Saint Denis (FR)

(73) Assignee: Valeo Systèmes d'Essuyage, Le Mesnil Saint Denis (FR)

(21) Appl. No.: 18/010,916

(22) PCT Filed: Jun. 15, 2021
(86) PCT No.: PCT/EP2021/066069

§ 371 Date: Dec. 16, 2022

(30) Foreign Application Priority Data
Jun. 16, 2020 (CN) 202010551262.2

(51) Int. Cl. B60S 1/40; B60S 1/52; B60S 1/38; B60S 1/34

(52) U.S. Cl. CPC B60S 1/4006; B60S 1/522; B60S 1/38; B60S 1/3425; B60S 2001/3812

(57) ABSTRACT

The present invention relates to a wiper and a vehicle. The present invention relates to a wiper and a vehicle. The wiper (1, 1′, 1″) comprises: a wiper arm (2) comprising a wiper arm holder (10), an extension arm (20), and a wiper arm end member (40), the wiper arm being drivable to swing back and forth in an outward swing direction and a return direction; a wiper blade (60) comprising a blade holding portion (61) and a blade rubber strip (63); a first nozzle (50) connected to the wiper arm end member (40); and a first conduit (71) for conveying a cleaning fluid under pressure to the first nozzle (50), wherein an end (71B) of the first conduit (71) that is used for connecting with the first nozzle (50) passes the wiper blade (60) between the wiper arm end member (40) and the blade holding portion (61) and extends to a first longitudinal side of the wiper blade (60).

### TECHNICAL FIELD

The present invention relates to a wiper and a vehicle.

### BACKGROUND ART

A wiper, important to a vehicle, is used to clean up rainwater and other contaminants on a windscreen that affect the driver's line of sight, thereby ensuring driving safety.

In a traditional wiper, a wiper assembly and a cleaning assembly are separated from each other, with the cleaning assembly hidden under the front hatch. When the windscreen needs to be cleaned, the cleaning assembly sprays a cleaning fluid onto the surface of the windscreen, and then the wiper assembly starts operating. Since the cleaning fluid is sprayed onto the entire surface of the windscreen, a large amount of cleaning fluid may be needed for the cleaning.

Wipers with nozzles arranged on the wiper arms are also known, as disclosed by document CN206704156U, for example. The disclosed water spray wiper structure comprises a wiper arm, a conduit arranged on the wiper arm, a water spray body, a wiper arm connector for connecting the water spray body to an end of the wiper arm, and a cover. The water spray body comprises a plurality of nozzle openings. The cover is clamped in a concealing fashion above the water spray body, and the wiper arm connector is clamped below the water spray body.

In the above-described water spray wiper structure, the cover for covering the water spray body is arranged on the side of the wiper arm in a swing direction of the wiper arm, which adversely causes an increase in the area on the windscreen covered by the wiper.

Therefore, a water spray wiper structure is desired that can achieve the best possible wiping effect with as little cleaning fluid as possible, and is as compact as possible.

### SUMMARY OF THE INVENTION

Therefore, an objective of the present invention is to propose a wiper that can at least partially solve the above-mentioned problem.

According to a first aspect of the present invention, a wiper for a vehicle is proposed, the wiper comprising:
a wiper arm comprising a wiper arm holder, an extension arm, and a wiper arm end member that are connected in a longitudinal shape, the wiper arm being drivable to swing back and forth in an outward swing direction and a return direction;
a wiper blade comprising a blade holding portion and a blade rubber strip, wherein the wiper blade is held by the blade holding portion at the wiper arm end member of the wiper arm, and the wiper holding portion holds the blade rubber strip;
a first nozzle connected to the wiper arm end member of the wiper arm; and
a first conduit for conveying a cleaning fluid under pressure to the first nozzle in an extension direction of the wiper arm,
wherein an end of the first conduit that is used for connecting with the first nozzle passes the wiper blade between the wiper arm end member and the blade holding portion and extends to a first longitudinal side of the wiper blade.

By this design solution, a cleaning fluid may, in a targeted manner, be directed to a longitudinal side of the wiper blade arranged at the wiper arm.

According to an embodiment of the present invention, a recess is provided on the side of the blade holding portion that faces away from the blade rubber strip, that is, the upper side, and the first conduit penetrates the recess and extends to a first longitudinal side of the wiper blade. This makes it possible to keep the distance between the upper side of the blade holding portion and the side of the wiper arm that faces the windscreen as small as possible, without adversely affecting the guiding of a conduit; thus, the wiper as a whole has a small height in the direction perpendicular to the windscreen in this area, and a compact structure is achieved.

According to an embodiment of the present invention, the first nozzle comprises a main body provided with a spout, as well as a conduit joint and a nozzle holding portion that protrude from the main body. Preferably, the conduit joint and the nozzle holding portion directly protrude from the main body. This is particularly advantageous to channels for a cleaning fluid that are designed in the conduit joint and the main body; they may be in direct communication with each other, so that a cleaning fluid inlet is formed at the end of a channel on the conduit joint side and a cleaning fluid outlet is formed at the other end on the spout side; since injection moulding, for example, of the nozzle is guaranteed without additional plugs, cost-effective manufacture is achieved. After being mounted, the first nozzle is located on a first longitudinal side of the wiper blade to spray a cleaning fluid.

According to an embodiment of the present invention, the wiper arm end member is provided, in particular stepwise, with a first web protruding in the direction of the first longitudinal side, the first web being used to hold the nozzle holding portion. Here, the expression “provided stepwise” may be understood to mean that the first web is dislocated, that is, staggered, relative to the main body of the wiper arm end member, for example, in the height direction of the wiper as a whole. In addition, the wiper arm end member may further be provided with a second web, wherein the first web and the second web are arranged side by side at a distance from each other, and the conduit joint is located below the second web. Therefore, especially when a second web is provided, by the separation of the first web from the second web, a channel through which air may pass is formed at the mounting position of the nozzle during the travelling of the vehicle; this allows a reduction in especially the load of an airflow on the nozzle and in the interference with a jet fluid from the nozzle. The first web and the second web may be oriented in the same direction to facilitate the mounting of a nozzle and a conduit. The second web arranged can also protect the connection between the conduit and the conduit joint.

According to an embodiment of the present invention, the wiper arm end member is in a zigzag shape, and is provided with a first segment for connecting with the extension arm, a second segment for holding the wiper blade, and an intermediate segment arranged between the first segment and the second segment, wherein the first segment and the second segment are staggered in a direction transverse to the longitudinal extension of the wiper arm, and the first web and the second web are arranged in the intermediate segment. For example, if necessary, the second segment may be positioned in front of the first segment with reference to the outward swing direction; therefore, a nozzle may be mounted simply by making the first web and the second web slightly protrude in the outward swing direction.

According to an embodiment of the present invention, the second segment is in the form of a U-shaped hook.

According to an embodiment of the present invention, the nozzle holding portion is in the form of a socket, which is inserted into the first web. The socket is preferably a blind hole, and is in the form of a bell mouth on the open side; this makes it easy to insert a web, which also facilitates demoulding in the injection moulding process.

According to an embodiment of the present invention, the first web and the second web are at least partially staggered up and down. For example, the degree of stagger may be such that the upper part of the inserted nozzle holding portion is flush with the upper part of the second web, so that an aesthetically appealing shape and a good aerodynamic effect may be achieved.

According to an embodiment of the present invention, the first longitudinal side is the outward swing side corresponding to the outward swing direction, the wiper blade is arranged on the outward swing side of the wiper arm, the first nozzle is arranged on the outward swing side of the wiper blade, and the end of the first conduit for connecting with the first nozzle extends to the outward swing side of the wiper blade. Thus, the wiper arm may be placed lower at the root of the mounting position of the windscreen, especially in the reset position of the wiper arm, that is, when the wiper is not in operation. Therefore, the wiper arm may be covered by the front hatch of the vehicle during travelling; when possible, the wiper blade may also be located under the rear edge of the front hatch, which is beneficial to improving the aesthetic appeal and aerodynamic characteristics of the vehicle as a whole.

According to an embodiment of the present invention, relative to the second segment, the first web and the second web are deflected downwards towards the windscreen to be wiped of the vehicle. Preferably, an angle at which the first web and the second web are deflected downwards corresponds to an inclination angle at which the windscreen is mounted. This causes the nozzle and the webs to create as little obstruction as possible in the observation line of sight in the viewing direction of the driver in the vehicle in the mounting position, thereby further ensuring driving safety.

According to an embodiment of the present invention, a holding arm for holding the first conduit is integrally formed on the wiper arm end member. This makes it possible to keep the conduit in a desired position without the need to arrange any additional components, thereby preventing the conduit from shaking or getting loose during the operation of the wiper. For example, holding arms may be arranged in pairs on opposite sides of the wiper arm end member, the corresponding free ends are spaced apart pointing to the windscreen, and the conduit may be elastically deformed into an accommodating space formed by the holding arm and the wiper arm end member.

According to an embodiment of the present invention, a second nozzle is provided, comprising a spout capable of spraying a cleaning fluid in different directions towards a second longitudinal side of the wiper blade that faces the first longitudinal side.

According to an embodiment of the present invention, the first nozzle is provided with a spout capable of spraying a cleaning fluid in different directions. Especially, if the above-described two nozzles are combined, a cleaning fluid may be sprayed separately when the wiper arm swings in the outward swing direction and the return direction, which allows a better cleaning effect to be achieved.

Since the first nozzle and the second nozzle can spray a cleaning fluid in different directions, the cleaning fluid may be sprayed to a desired position in a small amount while a good wiping effect is guaranteed.

According to another aspect of the present invention, a vehicle is proposed, which comprises the wiper as described above.

### BRIEF DESCRIPTION OF THE DRAWINGS

The present invention is expounded further below by means of the accompanying drawings. In the drawings:

FIG. 1 schematically shows a perspective view of embodiment 1 of a wiper according to the present invention;

FIG. 2 shows a schematic diagram for the swing of a wiper on a windscreen;

FIG. 3 shows a top view of the wiper as shown in FIG. 1;

FIG. 4 shows a partial enlarged view of the wiper as shown in FIG. 3;

FIG. 5 shows an illustration of the wiper blade of a wiper according to the present invention;

FIG. 6 shows a bottom view of the wiper arm of a wiper according to the present invention;

FIG. 7 shows a partial enlarged view of a segment of the wiper arm as shown in FIG. 6;

FIG. 8 shows a partial enlarged view of another segment of the wiper arm as shown in FIG. 6;

FIG. 9 shows a cross-sectional view taken along the line E-E in FIG. 4;

FIG. 10 shows a cross-sectional view taken along the line F-F in FIG. 4;

FIG. 11 shows a cross-sectional view taken along the line G-G in FIG. 7;

FIG. 12 shows an exploded view of the nozzle and the wiper arm of the wiper;

FIG. 13 schematically shows another perspective view of a wiper according to the present invention;

FIG. 14 schematically shows a mounting diagram for a wiper according to the present invention relative to the windscreen;

FIG. 15 schematically shows an exploded view of the second nozzle and the wiper arm of the wiper;

FIG. 16 schematically shows a spray direction of the second nozzle;

FIG. 17 shows a schematic diagram for embodiment 2 of a wiper according to the present invention; and

FIG. 18 shows a schematic diagram for embodiment 3 of a wiper according to the present invention.

### SPECIFIC EMBODIMENTS

Embodiments of the present invention are described demonstratively below. As those skilled in the art should realise, the embodiments described may be amended in various ways without departing from the concept of the present invention. Thus, the accompanying drawings and the Description are in essence demonstrative and non-limiting. In the following text, identical drawing reference labels generally indicate functionally identical or similar elements.

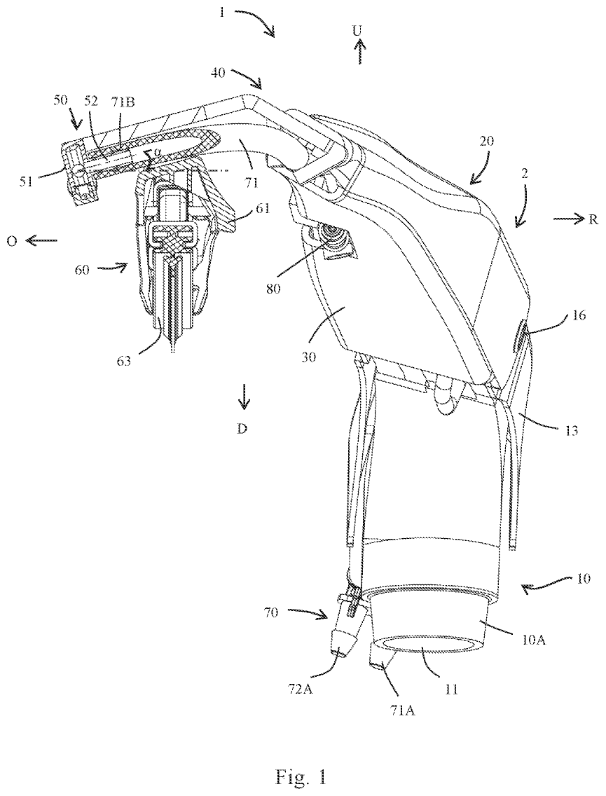

FIG. 1 shows a schematic diagram for a wiper 1 according to the present invention as viewed from the side away from a fixed end, the fixed end being connected to the drive mechanism of the wiper, for example, a drive part (for example, an output shaft) of a motor. The wiper 1 comprises a wiper arm 2 and a wiper blade 60, both of which have a longitudinal shape extending in the longitudinal direction and are detachably connected to each other in a known manner for wiping the windscreen G, and may be replaced if necessary.

The wiper 1 further comprises a cleaning assembly for spraying a cleaning fluid to the windscreen G, the cleaning assembly comprising a nozzle and a conduit that is used for guiding a cleaning fluid, wherein the nozzle is mounted on a relevant component of the wiper arm 2 and the conduit guides the fluid in the longitudinal extension direction of the wiper arm 2.

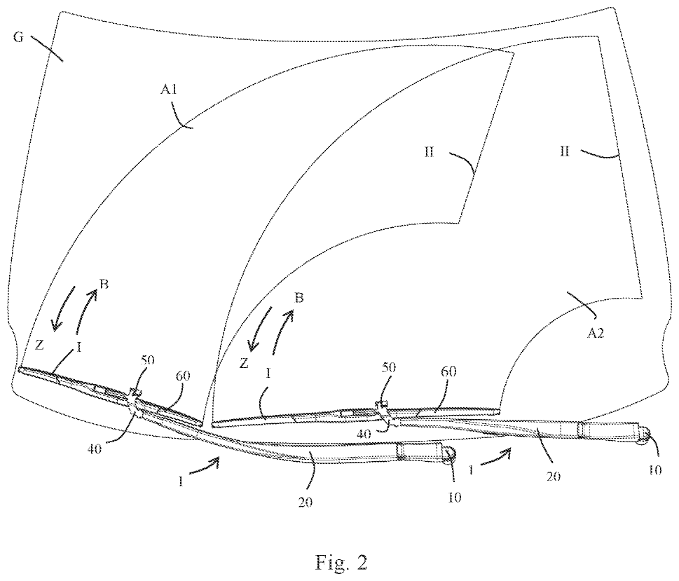

Regarding the operation of the wiper 1 as shown in FIG. 1, refer to FIG. 2. FIG. 2 exemplarily shows that two wipers 1 are arranged at the windscreen G in the same direction along the transverse direction of the vehicle. It should be noted that the number of wipers 1 arranged at the windscreen G may be increased or decreased on the basis of the size of the windscreen G to be wiped. Certainly, the wiper 1 may also be arranged opposite to the windscreen G. Each wiper 1 can swing back and forth on the windscreen G in the outward swing direction B and the return direction Z, thereby occupying the return pause position I and the outward swing pause position II, so that each wiper 1 wipes the wiping areas A1 and A2, respectively, between the two pause positions. It is clear that when a plurality of wipers are arranged, the corresponding wiping areas may have an overlapping area. Certainly, the reset position of the wiper 1, that is, the position occupied before the wiper is driven, may also be below the return pause position, so that when viewed from the front of the vehicle, the wiper assembly is covered by the hood of the vehicle; this is beneficial to reducing the wind resistance acting on the wiper when the vehicle is travelling and the wiper does not need to operate.

For ease of description, for the wiper 1 and its components, the side facing the windscreen G is called the lower side D, the side facing away from the windscreen G is called the upper side U, the side facing the return pause position I and corresponding to the return direction Z is called the return side R, and the side facing the outward swing pause position II and corresponding to the outward swing direction B is called the outward swing side O, as marked in FIG. 1.

The wiper arm 2 comprises: a wiper arm holder 10 connected, at one end 10A, that is, the above-mentioned fixed end, to an output portion of a drive mechanism for the wiper arm, the drive mechanism being, for example, a motor, or comprising at least a motor, to drive the wiper arm 2 to swing back and forth in the outward swing direction B and the return direction Z; an extension arm 20 that is rotatably connected, for example, being pivotally connected, with the other end 10B of the wiper arm holder 10, and on which a longitudinal intermediate portion of the wiper arm is formed; a wiper arm end member 40 arranged on the other side of the wiper arm 2 opposite to the wiper arm holder 10, for holding the wiper blade 60. The wiper blade 60 comprises a blade holding portion 61 and a blade rubber strip 63. The wiper blade 60 is held at the free end of the wiper arm end member 40 of the wiper arm 2 by the connecting portion 62 of the wiper holding portion 61, and the blade holding portion 61 holds the blade rubber strip 63.

The wiper arm holder 10 is usually die-cast from aluminium or aluminium alloy. The end 10A on the fixed side of the wiper arm holder 10 is provided with a cylindrical hole 11 for the shaft of a drive mechanism not shown, wherein the shaft, functioning as the output part of the drive mechanism, is fixed in the cylindrical hole 11 so as to be not rotatable relatively; thus, the drive mechanism transmits driving motion to the wiper arm via the shaft, so that the wiper arm can swing back and forth between the above-mentioned two pause positions.

As is clear from FIGS. 1, 3, and 7, the wiper arm holder 10 is rotatably connected with the extension arm 20 via a pivot 16 at the other end 10B opposite to the end 10A. The pivot 16 passes through the wiper arm holder 10 and the extension arm 20 transversely to the longitudinal extension direction of the wiper arm 2.

A channel (not shown) for a conduit is further provided in the wiper arm holder 10. The channel can also be considered as extending in a longitudinal direction, that is, extending from one end facing the end 10A to the other end 10B and to the extension arm 20, such that the conduit unit 70 can be introduced into the extension arm 20.

The cover 13 is arranged on the upper side of the wiper arm holder 10. For example, the cover 13 is rotatably arranged at one end in the pivoting position of the wiper arm holder and of the extension arm, and the side wall is provided with a position-limiting structure which is, for example, in the form of a rib and a hook. The cover 13 can cover the wiper arm holder and the conduit. If necessary, the cover 13 can extend above the cylindrical hole 11 to cover the output shaft in the cylindrical hole 11.

The extension arm 20 may also be deemed an elongated piece, which is, for example, a sheet metal member. The extension arm 20 has a U-shaped cross-section substantially over its entire longitudinal extension length, wherein the opening of the U shape faces the lower side D. Therefore, the extension arm 20 may be provided with an upper wall portion 21A as well as side walls 21B and 21C on either side of the upper wall portion. In the mounting position, the two side walls respectively extend from the edge of the upper wall portion 21A towards the side facing the windscreen G. The shape of the upper wall portion 21A should be designed according to aerodynamics to reduce the load of the wind acting on the extension arm when the vehicle is travelling.

The open lower side of the extension arm 20 may be equipped with a bottom cover 30 at least in part of the segment.

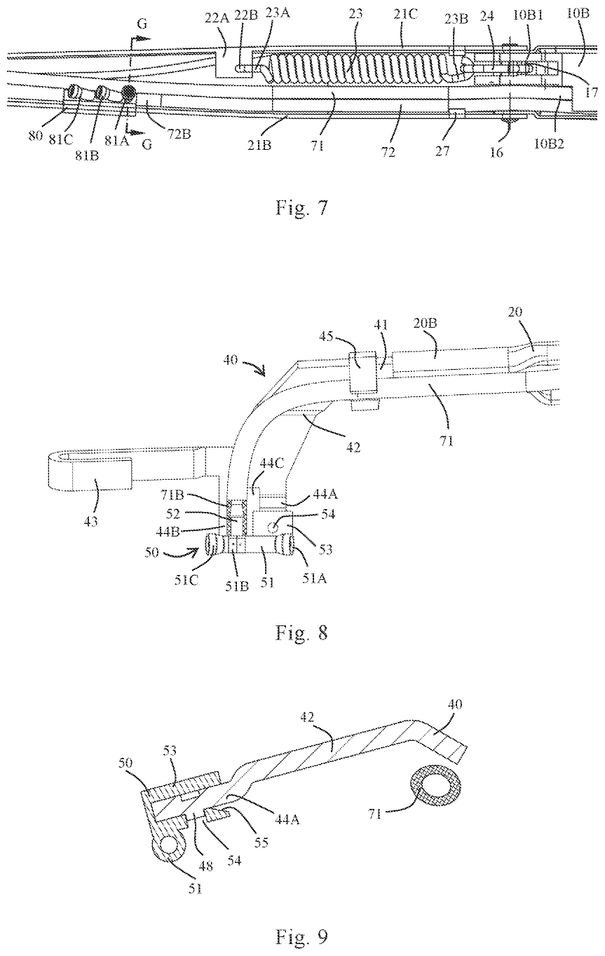

At the joint between the wiper arm holder 10 and the extension arm 20, the other end 10B of the wiper arm holder 10 is located between the inner walls of the side walls 21B and 21C of the extension arm 20, as shown in FIG. 7. Two ends of the pivot 16 mentioned above that connects the wiper arm holder 10 and the extension arm 20 may be pressed against the outer walls of the side walls 21B, 21C in such a manner that the outer diameter of the two ends of the pivot 16 is greater than the inner diameter of perforations, not shown, in the side walls of the extension arm, so as to realise the rotation of the wiper arm holder 10 relative to the extension arm 20.

A spring element 23 is arranged in the extension arm 20 for applying a preload to the extension arm 20 to deflect the extension arm in the direction of the windscreen, so that the rubber strip 63 of the wiper blade 60 butts up against the windscreen. A first end 23A of the spring element 23 is held at the extension arm or a member fixedly connected to the extension arm, and a second end 23B thereof is connected to the wiper arm holder, wherein, in a mounted state of the spring element 23, it is lengthened relative to the original state, thereby applying the preload. For this purpose, for example, on the edge of one side wall 21C of the extension arm 20, a web 22A protruding towards the other side wall 21B is arranged, the web being provided with an opening 22B into which the first end 23A of the spring element 23 is hung. A bolt shaft 17 is arranged at the other end 10B of the wiper arm holder 10 between the inner walls of the side walls 21B and 21C of the extension arm 20, and the second end 23B of the spring element 23 is hooked on the bolt shaft 17 via a C-shaped member 24.

The bolt shaft 17 may be provided separately and then mounted at the other end 10B. Alternatively, the bolt shaft 17 may also be integrally formed at the other end 10B. The open side of the C-shaped member 24 faces the upper wall portion 21A of the extension arm 20.

In a state where the spring element 23 is properly mounted, the other end 10B of the wiper arm holder 10 butts up against the extension arm 20 with its side facing the upper wall portion 21A of the extension arm 20 under the action of the spring element, thereby limiting the initial positions of the wiper arm holder 10 and the extension arm 20. Certainly, other limitation solutions are also feasible. The other end 10B is divisible into a first part 10B1 and a second part 10B2 in the width direction of the wiper arm holder 10, wherein the front end of the first part 10B1 is U-shaped. Thus, for example, when the extension arm is rotated around the pivot 16 into the drawing surface of FIG. 7 in order to replace the wiper blade, that is, when the rotation direction points to the inside of the drawing surface of FIG. 7 so that the extension arm rotates away from the windscreen, the C-shaped member 24 is prevented from coming into contact with the front end of the first part 10B1. In other words, the provided spring element should not hinder the relative movement of the wiper arm holder 10 and the extension arm 20 in a predetermined direction. On the second part 10B2, a part of a channel for a conduit is formed; in other words, the conduit enters the extension arm through the second part 10B2.

The extension arm 20, at the other end 20B thereof, is fixedly connected to the wiper arm end member 40. For example, the extension arm 20 at least partially surrounds the first segment 41 of the wiper arm end member 40 at the end 20B, as shown in FIG. 8. The wiper arm end member 40 will be further described below.

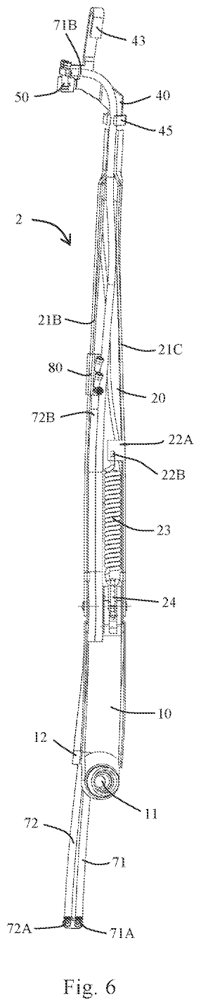

In addition, as is particularly clear from FIG. 6, especially the extension arm 20, the spring element 23 occupies a partial segment of the side of the extension arm 20 facing the wiper arm holder 10, and the extension arm 20 has a gradually decreasing width in its entire length direction.

The wiper arm end member 40 may also be a sheet metal member. In particular, the wiper arm end member 40 has a zigzag shape and, therefore, may be basically deemed a crank-shaped elongated member. The wiper arm end member 40 is provided with a first segment 41 for connecting with the extension arm 20, a second segment 43 for holding the wiper blade 60, and an intermediate segment 42 arranged between the first segment 41 and the second segment 43. The first segment 41 and the second segment 43 are staggered in a direction transverse to the extension direction of the wiper arm 2 so that the second segment 43 is located in front of the first segment 41 with reference to the outward swing direction B.

In the example shown, the second segment 43 is in the form of a U-shaped hook. However, the second segment 43 may also be in other forms, including but not limited to, J-shaped hooks, N-shaped hooks, E-shaped hooks, bayonet chucks, internal locking chucks, and side locking chucks. The corresponding connection portion of the wiper blade has a structure that matches the corresponding mounting segment.

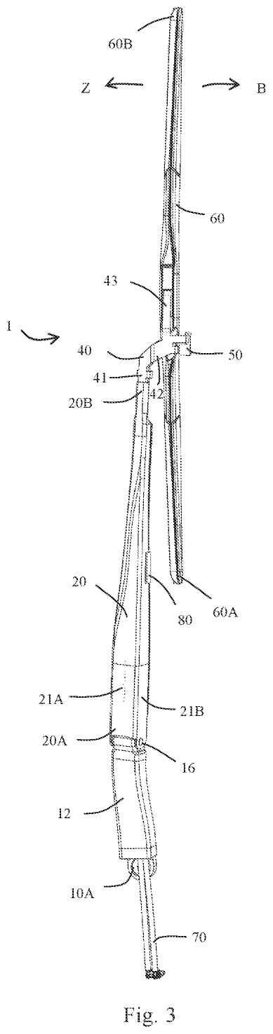

The nozzle of the wiper 1 is mounted at the wiper arm 2. In the example given, two nozzles 50 and 80 respectively mounted at the extension arm 20 and the wiper arm end member 40 are shown (see FIG. 3), wherein the first nozzle 50 is arranged relative to the wiper blade on the outward swing side thereof, and the second nozzle 80 is arranged on the return side; they are respectively used to, when the wiper blade swings in the outward swing direction B and the return direction Z, spray a cleaning fluid, for example, a glass-cleaning liquid, on the windscreen towards the return side and outward swing side of the wiper blade. The first nozzle 50 is equipped with a first conduit 71, and the second nozzle is equipped with a second conduit 72, wherein the first conduit 71 and the second conduit 72 are kept at the wiper arm 2 in the direction of the wiper arm, and the length of a conduit is set according to the mounting position of a nozzle.

The first nozzle 50 is provided with a main body 51 that is equipped with a spout, as well as a conduit joint 52 and a nozzle holding portion 53 that protrude from the main body 51. For example, the conduit joint 52 and the nozzle holding portion 53 may form an angle of 90° with the main body 51. Certainly, other angles are also feasible.

The main body 51 is provided with a spout and preferably a plurality of spouts. For example, the first nozzle 50 is provided with a first spout 51A for spraying a fluid towards one end of the wiper blade, a second spout 51B for spraying a fluid towards the windscreen G, and a third spout 56C for spraying a fluid towards the opposite end of the wiper blade. Preferably, a fluid spraying direction of a corresponding spout of the first nozzle 50 is adjustable.

The end 71B of the first conduit 71 that conveys a cleaning fluid under pressure to the first nozzle 50 is hermetically connected to the conduit joint 52 of the first nozzle 50 such that they do not get loose. For this purpose, in particular, the front end of the conduit joint 52 is in the shape of a truncated cone.

The nozzle holding portion 53 may be in the form of a socket.

As is particularly clear from FIG. 12, the conduit joint 52 and the nozzle holding portion 53 have the same orientation, and they are arranged side by side in the longitudinal direction of the wiper arm.

With this structure of the first nozzle 50, a fluid flow path formed in the conduit joint 52 and a fluid flow path formed in the main body 51 may be in direct communication with each other, which is particularly advantageous to the manufacture of first nozzles by injection moulding, without the need for a plug used when there is an intermediate flow path.

In order to keep the first nozzle 50 at the wiper arm 2, especially on the outward swing side of the wiper arm end member 40, the wiper arm end member 40 is provided with a first web 44A and a second 44B that stick out on the outward swing side; they are arranged side by side at a distance from each other, wherein the first web 44A is used to hold the nozzle holding portion 53, and the conduit joint 52 is arranged below the second web 44B. Herein, the first web 44A and the second web 44B may be deemed to be protruding in a direction transverse to the longitudinal extension direction of the wiper arm.

Preferably, the first web 44A and the second web 44B are arranged at the intermediate segment 42 of the wiper arm end member 40, as is particularly clear from FIG. 12.

Therefore, the wiper blade 60 may be deemed to be on the outward swing side of the wiper arm 2 corresponding to the outward swing direction B, and the first nozzle 50 is arranged on the outward swing side of the wiper blade 60 corresponding to the outward swing direction B; therefore, especially in the reset position of the wiper, the wiper arm 2 may be placed as low as possible at the root of the mounting position of the windscreen, which allows an improvement in the aesthetic appeal and aerodynamic characteristics of the vehicle as a whole.

The first web 44A and the second web 44B are arranged at a distance from each other. In other words, a notch 44C is left between them. After the first nozzle 50 is inserted into the first web 44A in the direction I shown in FIG. 12, the notch 44C is not completely filled by the side of the nozzle holding portion 53. Therefore, when the vehicle is travelling, the notch, not completely filled, can form a channel through which air may flow, thereby reducing the load of an airflow acting on this area.

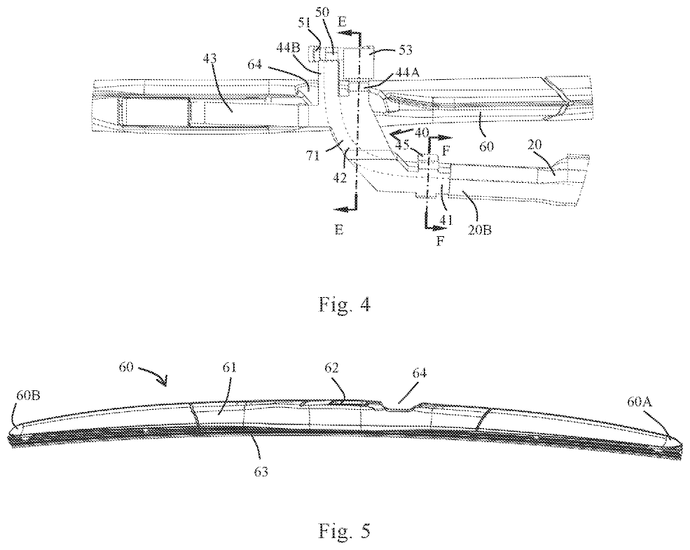

FIGS. 4 and 8 show different illustrations of a state where the first nozzle 50 is properly mounted at the wiper arm end member. It is clear that the end 71B of the first conduit 71 for connecting with the first nozzle 50 extends between the wiper arm end member 40 and the blade holding portion 61 to the outward swing side of the wiper blade 60, and, particularly, is connected to the conduit joint 52 of the first nozzle 50 under the second web 44B.

An example of the connection between the first web 44A and the nozzle holding portion 53 of the first nozzle 50 is shown in the cross-sectional view of FIG. 9. The nozzle holding portion 53 structured as a socket is provided with a through hole 54 in the wall portion on the side facing the windscreen. Preferably, the open side of the nozzle holding portion 53 is a tapered opening 55. A bulge 48 is formed on the first web 44A. When assembled properly, the bulge 48 just falls into the through hole 54 so that the nozzle is held on the first web 44A. The number of through holes 54 and that of bulges 48 may be set as needed. Certainly, other methods for connecting the first web 44A with the nozzle holding portion 53, such as bonding, are also feasible.

Preferably, at least a partial segment of the first web 44A of the nozzle holding portion 53 of the first nozzle 50 may be vertically staggered with respect to the second web 44A, and, in particular, a stagger distance is set such that the upper part of the inserted nozzle holding portion is flush with the upper part of the second web, thereby achieving a good visual effect after installation.

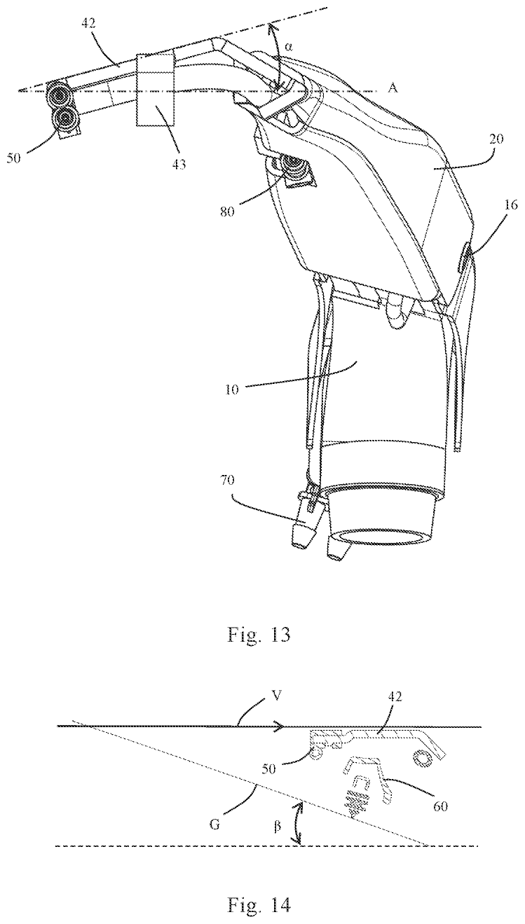

Preferably, the segment of the wiper arm end member 40 that is provided with the first web 44A and the second web 44B transitions, via a transition segment 46, in a torsional manner into the U-shaped hook forming the second segment 43. In other words, neither of the two webs is spatially parallel to the U-shaped hook. The U-shaped hook may be considered to be substantially parallel to the windscreen G, thereby keeping the wiper blade perpendicular to the windscreen G; the first web 44A and the second web 44B form an angle α with the windscreen G. Specifically, with respect to the second segment 43, the first web 44A and the second web 44B are deflected downwards towards the windscreen to be wiped of the vehicle. Preferably, an angle at which the first web and the second web are deflected downwards corresponds to an inclination angle β at which the windscreen is mounted, as shown in FIG. 13 and FIG. 14. Therefore, when the wiper is mounted on the windscreen of the vehicle, as viewed along the observation direction V of the driver in the vehicle, the nozzle and the webs create as little obstruction as possible in the observation line of sight; this allows a reduction of interference by the wiper with the driver, thereby guaranteeing driving safety.

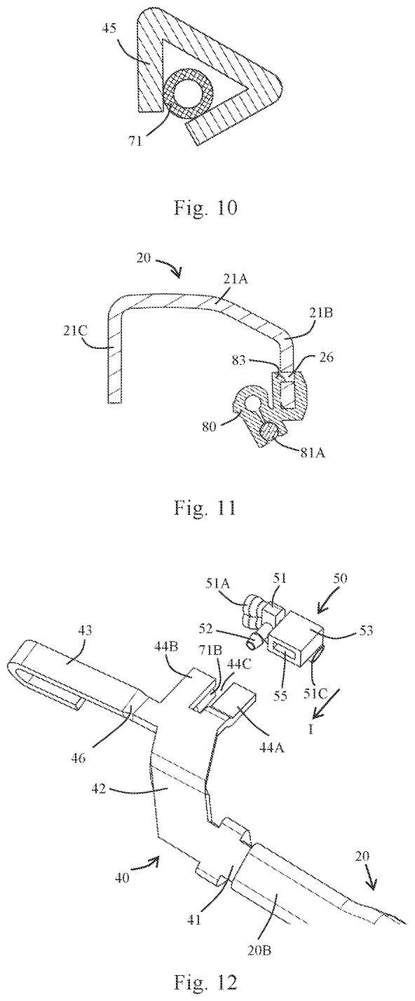

On the wiper arm end member 40, a holding arm 45 for the first conduit 71 may also be integrally formed. Holding arms 45 may be arranged in pairs on opposite sides of wiper arm end members, and the corresponding free ends are spaced apart pointing to the windscreen; a conduit may be elastically deformed into an accommodating space formed by the holding arm and the wiper arm end member, as shown in FIG. 8 and FIG. 10.

In order to minimise the size of the wiper in the direction perpendicular to the windscreen G, a recess 64 may be provided on the upper side of the blade holding portion 61 of the wiper blade 60, and the first conduit 71 passes through the recess 64 and extends to the outward swing side of the wiper blade 60, as shown in FIGS. 4 and 5.

FIG. 3 shows the second nozzle 80 mounted on the return side of the wiper blade corresponding to the return direction. Although it is shown that the second nozzle 80 is mounted on the side wall 21B on the outward swing side of the wiper arm, it may also be mounted on the side wall 21C or in any other suitable position, as long as a jet fluid from the second nozzle is not blocked. The second nozzle 80 is connected to the end 72B of the second conduit 72 through the interface 84.

Preferably, the second nozzle 80 is mounted at such a location of the wiper arm 2 that is next to the end 60A of the wiper blade 60 facing the fixed end of the wiper arm 2, as shown in FIG. 3.

The second nozzle 80 may be provided with a plurality of spouts, which may be oriented in different directions. In the example given, three spouts 81A, 81B, and 81C are shown, wherein the spout 81A is oriented perpendicular to the windscreen G, while the spouts 81B and 81C are oriented obliquely at different angles relative to the windscreen. Certainly, other numbers of spouts are also feasible.

The spray directions of the cleaning fluid leaving the spouts of the second nozzle 80 are shown in FIG. 16. It is clear that, unlike the first nozzle 50, the second nozzle 80 sprays a cleaning fluid in one direction as a whole, that is, spraying a cleaning fluid in the main direction that points from one end 60A of the wiper blade 60 to the other end 60B. In this case, when the wiper swings from the outward swing pause position II to the return pause position I, especially when the vehicle is travelling, the sprayed cleaning fluid is guided towards the other end 60B along the blade rubber strip 63 under the action of head-on wind, so that the cleaning fluid can cover the entire length of the blade rubber strip 63 to achieve a good wiping effect.

Preferably, one of the spouts of the second nozzle 80 is oriented perpendicularly to the windscreen, and at least one spout is oriented obliquely towards the other end 60B of the wiper blade.

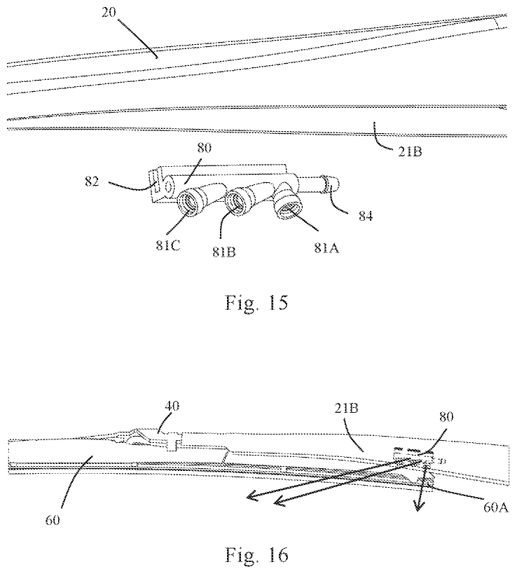

As is clear from FIGS. 11 and 15, the second nozzle 80 may be clamped at a side wall 21B of the extension arm 20. For this purpose, the second nozzle 80 may be provided with a bayonet 82 having a hook 83, the bayonet 82 having a width that matches the thickness of the side wall 21B. A notch 26 is preformed in the side wall 21B, and the hook 83 is hooked into the notch 26. The number of hooks 83 and notches 26 may be set as required. Certainly, the second nozzle 80 may also be held at the extension arm in other manners.

Therefore, when the first nozzle is combined with the second nozzle, a cleaning fluid may be sprayed separately when the wiper swings in the outward swing direction and the return direction, and a cleaning fluid may also be sprayed in a small amount to a desired location while a good cleaning effect is guaranteed.

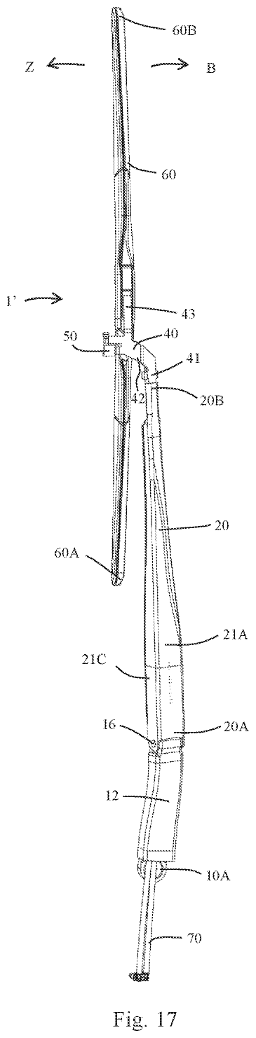

FIG. 17 shows a schematic diagram for embodiment 2 of a wiper 1′ according to the present invention, wherein the main difference between the wiper 1′ and the wiper 1 is the structure of the wiper arm end member 40 of the wiper arm 2. The following description is given in connection with the differences only. For details about other parts, see the preceding description.

As is clear from FIG. 17, the wiper arm end member 40 is also in a zigzag shape; in other words, it consists of a first segment 41 for connecting with the extension arm 20, a second segment 43 for holding the wiper blade 60, and an intermediate segment 42 arranged between the first segment 41 and the second segment 43, wherein the first segment 41 and the second segment 43 are staggered in a direction transverse to a longitudinal extension direction of the wiper arm 2. However, unlike in FIG. 3 where the second segment 43 is located in front of the first segment 41 with reference to the outward swing direction B, the second segment 43 in FIG. 17 is located behind the first segment 41 with reference to the outward swing direction B.

In this case, the webs for the first nozzle 50, which are spaced apart from each other, are arranged on a longitudinal side of the intermediate segment 42 corresponding to the return direction Z. In other words, the first nozzle 50 is used to spray a liquid when the wiper arm swings in the return direction Z. A conduit for the first nozzle 50 passes the wiper arm and extends to a longitudinal side of the wiper blade corresponding to the return direction Z.

Likewise, a second nozzle (not shown herein) may be provided for spraying a liquid when the wiper arm swings in the outward swing direction B.

Other structures having favourable aerodynamic characteristics may also be provided in other parts of the wiper arm end member 40.

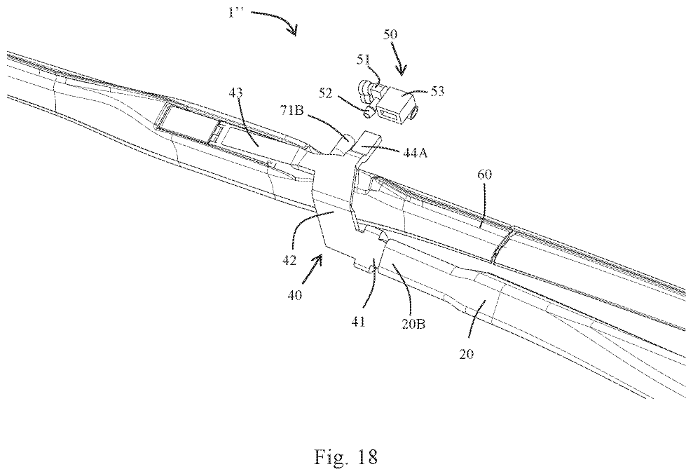

FIG. 18 shows a schematic diagram for embodiment 3 of a wiper 1″ according to the present invention, wherein the main difference between the wiper 1″ and the wiper 1 is also the structure of the wiper arm end member 40 of the wiper arm 2. The following description is given in connection with the differences only. For details about other parts, see the preceding description.

As may be seen from FIG. 18, only one web 44A is provided at the intermediate segment 42 of the wiper arm end member 40, for holding the nozzle holding portion 53 of the nozzle 50. The web 44A also protrudes towards a longitudinal side of the wiper blade 60. The web 44A is particularly arranged stepwise at the intermediate segment 42; in other words, the web 44A is dislocated relative to the intermediate segment 42 so that after the nozzle 50 is mounted on the wiper arm end member 40, the upper part of the nozzle holding portion 53 of the nozzle 50 and the upper part of the wiper arm end member 40 form a smooth transition, thereby forming an aesthetically appealing shape and improving aerodynamic characteristics.

The end 71B of a conduit for the nozzle 50 is also connected to, but is not covered by, the conduit joint 52 of the nozzle 50.

It should be noted that, in the present invention, the first nozzle 50 and the second nozzle 80, as described above, of the cleaning assembly may also be used alternatively, and that the conduits for them are respectively provided with adapters 71A and 72A for connecting to a cleaning fluid storage container not shown herein.

It should be noted that the wiper arm end member and the extension arm may also be connected to each other indirectly, that is, via another component.

The present invention is not limited to the structure described above; various other variants could also be used. Although the present invention has already been described by means of a limited number of embodiments, those skilled in the art could, drawing benefit from this disclosure, design other embodiments which do not depart from the scope of protection of the present invention disclosed herein. Thus, the scope of protection of the present invention should be defined by the attached claims alone.

1. A wiper for a vehicle, the wiper comprising:
a wiper arm comprising a wiper arm holder, an extension arm, and a wiper arm end member that are connected in a longitudinal shape, the wiper arm being drivable to swing back and forth in an outward swing direction and a return direction;
a wiper blade comprising a blade holding portion and a blade rubber strip, wherein the wiper blade is held by the blade holding portion at the wiper arm end member of the wiper arm, and the wiper holding portion holds the blade rubber strip;
a first nozzle connected to the wiper arm end member of the wiper arm;
a first conduit for conveying a cleaning fluid under pressure to the first nozzle in an extension direction of the wiper arm,
wherein the first conduit is provided with an end for connection with the first nozzle, and is arranged between the wiper arm end member and the blade holding portion, passing the wiper blade and extending to a first longitudinal side of the wiper blade.

2. The wiper according to claim 1, wherein a recess is provided on the side of the blade holding portion that faces away from the blade rubber strip, and the first conduit passes through the recess and extends to a first longitudinal side of the wiper blade.

3. The wiper according to claim 2, wherein the first nozzle is provided with a main body that is equipped with a spout, as well as a conduit joint and a nozzle holding portion that protrude from the main body.

4. The wiper according to claim 3, wherein the wiper arm end member is provided with a first web protruding towards the first longitudinal side, the first web being used to hold the nozzle holding portion.

5. The wiper according to claim 4, wherein the first web is stepwise arranged at the wiper arm end member.

6. The wiper according to claim 5, wherein the wiper arm end member is further provided with a second web, the first web and the second web are arranged side by side at a distance from each other, and the conduit joint is located below the second web.

7. The wiper according to claim 6, wherein the wiper arm end member is in a zigzag shape and is provided with a first segment for connection with the extension arm, a second segment for holding the wiper blade, and an intermediate segment arranged between the first segment and the second segment, wherein the first segment and the second segment are offset in a direction transverse to a longitudinal extension direction of the wiper arm, and the first web and the second web are arranged in the intermediate segment.

8. The wiper according to claim 7, wherein the second segment is in the form of a U-shaped hook.

9. The wiper according to claim 7, wherein the nozzle holding portion is in the form of a socket, which is inserted into the first web.

10. The wiper according to claim 9, wherein the first web and the second web are at least partially offset upward and downward.

11. The wiper according to claim 1, wherein the first longitudinal side is an outward swing side corresponding to the outward swing direction, and the wiper blade is arranged on the outward swing side of the wiper arm, the first nozzle is arranged on the outward swing side of the wiper blade, and the end of the first conduit that is used for connecting with the first nozzle extends to the outward swing side of the wiper blade.

12. The wiper according to claim 8, wherein, relative to the U-shaped hook-like portion of the second segment, the first web and the second web B are deflected downwards towards the windscreen to be wiped of the vehicle.

13. The wiper according to claim 12, wherein an angle at which the first web and the second web are deflected downwards corresponds to an inclination angle at which the windscreen is mounted.

14. The wiper according to claim 1, wherein a holding arm for holding the first conduit is integrally formed on the wiper arm end member.

15. The wiper according to claim 1, further comprising a second nozzle that is provided with a spout for spraying a cleaning fluid in different directions to a second longitudinal side of the wiper blade that faces the first longitudinal side.

16. The wiper according to claim 1, wherein the first nozzle is provided with a spout for spraying a cleaning fluid in different directions.

17. A vehicle, comprising the wiper according to claim 1.
